(19) United States
(12) Patent Application Publication
(10) Pub. No.: US 2018/0341647 A1
(43) Pub. Date: Nov. 29, 2018

(54) INFORMATION PROCESSING APPARATUS AND INFORMATION PROCESSING METHOD

(71) Applicant: CANON KABUSHIKI KAISHA, Tokyo (JP)

(72) Inventors: Tomonobu Hiraishi, Tokyo (JP); Atsushi Inoue, Tokyo (JP); Satoko Saito, Kawasaki-shi (JP); Toshiyuki Noguchi, Tokyo (JP)

(21) Appl. No.: 15/985,810

(22) Filed: May 22, 2018

(30) Foreign Application Priority Data
May 26, 2017 (JP) 2017-104300

(51) Int. Cl. G06F 17/30; G06F 17/24; G06T 11/60; G06K 9/60

(52) U.S. Cl. CPC G06F 17/30; G06K 9/60; G06T 11/60; G06F 17/24

(57) ABSTRACT

An information processing apparatus includes: a display controlling unit configured to control display so that a part of an image is displayed in a frame; and a storage unit configured to store history data including identification information for uniquely identifying the image, frame information for uniquely identifying the frame in which the image is displayed, and range information indicating a position of the part of the image displayed in the frame, wherein in a case of displaying a first image in a first frame, the display controlling unit acquires first history data including identification information on the first image and frame information on the first frame from the storage unit as corresponding history data, and controls display so that a part of the first image, which corresponds to a position indicated by range information in the corresponding history data, is displayed in the first frame.

### BACKGROUND OF THE INVENTION

### Field of the Invention

The present invention relates to a control method of an information processing apparatus.

### Description of the Related Art

There are systems which enable an electronic book to be readily created by selecting an image to be arranged on a prescribed template and inputting a comment related to the image. The template includes an image display frame for arranging the selected image and a comment input field for inputting a comment related to the image. When a user selects an image to be arranged in the image display frame and specifies a range of the image to be fit within the image display frame, a clipping (trimming) process of the image is performed in accordance with a shape of the image display frame and a portion corresponding to the specified range of the image is arranged inside the image display frame. In addition, a comment input to the comment input field is displayed in a vicinity of the image.

For example, Japanese Patent Application Laid-open No. 2011-186927 discloses a system in which one of a single-page layout and a double-page spread layout is specified for each image, a clipping process of the image is performed in accordance with the specified layout, and the image is arranged in each page.

### SUMMARY OF THE INVENTION

However, when, after arranging an image on a template, changing the template on which the image is arranged or changing the image arranged on the template, a range of the image to be fitted inside the image display frame must be specified once again and work must be redone. In addition, when a same image is to be used on another page, a range of the image to be fitted inside the image display frame must be specified once again, which means that previous work cannot be effectively utilized.

In consideration of the problems described above, an object of the present invention is to provide a system which reduces an amount of work by a user when changing a template and an image.

The present invention in its first aspect provides an information processing apparatus, comprising:

a display controlling unit configured to control display so that a part of an image is displayed in a frame; and

a storage unit configured to store history data including identification information for uniquely identifying the image, frame information for uniquely identifying the frame in which the image is displayed, and range information indicating a position of the part of the image displayed in the frame, wherein

in a case of displaying a first image in a first frame, the display controlling unit acquires first history data including identification information on the first image and frame information on the first frame from the storage unit as corresponding history data, and controls display so that a part of the first image, which corresponds to a position indicated by range information in the corresponding history data, is displayed in the first frame.

The present invention in its second aspect provides an information processing method, comprising:

controlling display so that a part of an image is displayed in a frame; and

recording, in a storage unit, history data including identification information for uniquely identifying the image, frame information for uniquely identifying the frame in which the image is displayed, and range information indicating a position of the part of the image displayed in the frame, wherein

in a case of displaying a first image in a first frame, in the controlling.

first history data including identification information on the first image and frame information on the first frame is acquired from the storage unit as corresponding history data, and

display is controlled so that a part of the first image, which corresponds to a position indicated by range information in the corresponding history data, is displayed in the first frame.

The present invention in its third aspect provides a non-transitory computer readable medium that stores a program, wherein

the program causes a computer to execute:

controlling display so that a part of an image is displayed in a frame; and

recording, in a storage unit, history data including identification information for uniquely identifying the image, frame information for uniquely identifying the frame in which the image is displayed, and range information indicating a position of the part of the image displayed in the frame, and

in a case of displaying a first image in a first frame, in the controlling,

first history data including identification information on the first image and frame information on the first frame is acquired from the storage unit as corresponding history data, and

display is controlled so that a part of the first image, which corresponds to a position indicated by range information in the corresponding history data, is displayed in the first frame.

According to the present invention, an amount of work by a user when changing a template or a frame for arranging and displaying an image can be reduced.

Further features of the present invention will become apparent from the following description of exemplary embodiments with reference to the attached drawings.

### BRIEF DESCRIPTION OF THE DRAWINGS

FIG. 1 is a diagram showing an example of a hardware configuration of an information processing apparatus;

FIG. 2 is a flow chart showing an example of a process of creating an electronic book;

FIGS. 3A and 3B are diagrams showing an example of a user interface for selecting image data;

FIGS. 4A and 4B are diagrams showing an example of a user interface for editing a page:

FIG. 5 is a diagram showing an example of a data structure of book data;

FIGS. 6A to 6E are diagrams showing an example of a clipping process screen;

FIGS. 7A and 7B are diagrams showing an example of a data structure of a clip information management table:

FIG. 8 is a flow chart of a process for changing a template or an image;

FIGS. 9A and 9B are diagrams showing an example of a process of acquiring a clip start position and a magnification ratio; and

FIGS. 10A to 10D are diagrams showing an example of settings of a prioritized region and an excluded region.

### DESCRIPTION OF THE EMBODIMENTS

Hereinafter, a preferred embodiment of the present invention will be described in detail with reference to the drawings. In the respective diagrams, as a general rule, a same reference numeral will be assigned to a same component and overlapping descriptions will be omitted. In addition, unless otherwise noted, numerical values and the like that are exemplified in order to substantiate the description are not intended to limit the scope of the present invention thereto.

Furthermore, it is to be understood that the present invention is not limited to the embodiment described below and modifications may be appropriately made without departing from the spirit and scope of the invention. For example, respective components of the embodiment described below may be appropriately corrected or modified according to a configuration of an apparatus to which the present invention is applied and according to various conditions.

### First Embodiment

Hardware Configuration of Information Processing Apparatus 100

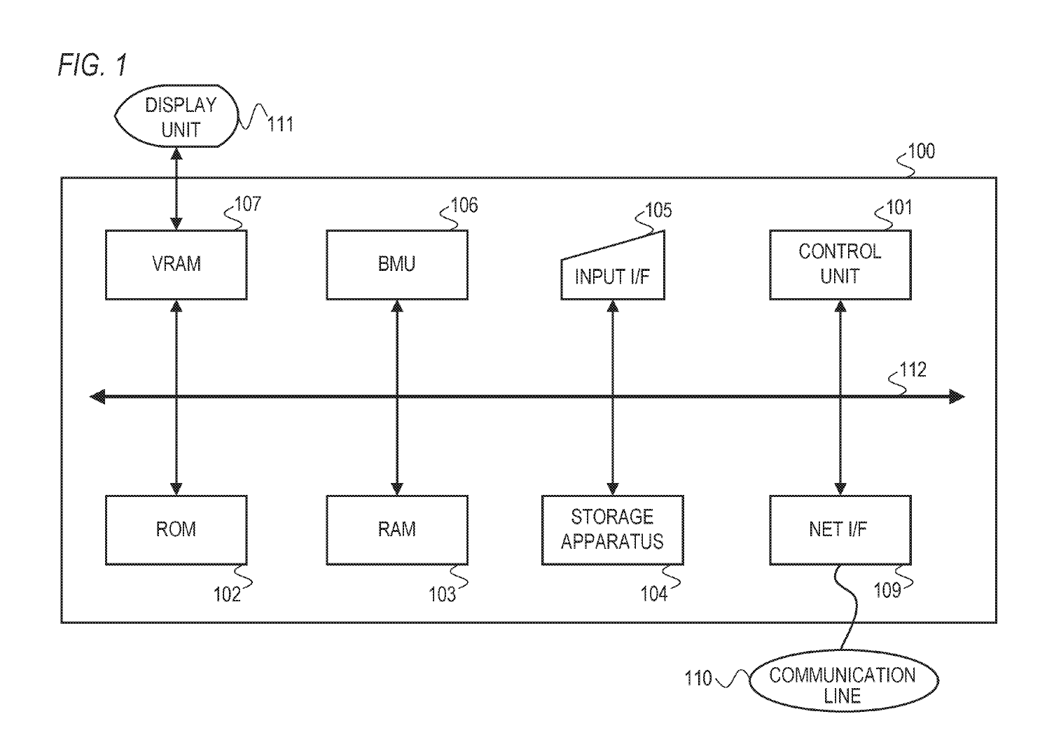

FIG. 1 is a diagram showing an example of a hardware configuration of an information processing apparatus 100. In FIG. 1, a control unit 101 controls the entire information processing apparatus 100 and is, for example, a central processing unit (CPU). A read only memory (ROM) 102 stores programs and parameters which need not be changed. A random access memory (RAM) 103 temporarily stores programs and data supplied from an external apparatus or the like. A storage apparatus 104 (a storage unit) is a hard disk, a memory card, or the like installed in an fixed manner to the information processing apparatus 100 and stores programs such as an operating system (OS). An input interface 105 receives an operation by a user and connects to an input apparatus such as a pointing device or a keyboard for inputting data. A bit move unit (BMU) 106 controls data transfer between, for example, memories (for example, a VRAM 107 and another memory) or a memory and each I/O device (for example, a network interface 109). The Video RAM (VRAM) 107 draws an image to be displayed on a display unit 111. An image generated on the VRAM 107 is transmitted to the display unit 111 according to a prescribed rule, and the display unit 111 displays the received image. The network interface (NET I/F) 109 connects to a network line 110 such as the Internet. A system bus 112 is a communication pathway of the respective units 101 to 109.

The information processing apparatus 100 creates an electronic book by arranging an image selected by the user for each page in a frame provided for each page. Respective functions for creating an electronic book are realized by the control unit 101.

The control unit 101 has a function as a display controlling unit which provides control so that a part of the image is displayed in the frame. For example, the control unit 101 generates a clipped image by a clipping process and arranges the clipped image in the frame. The clipping process is a process of cutting out a range of the image selected by the user and magnifying or demagnifying the cut-out image in accordance with a shape of the frame in which the cut-out image is to be arranged. In addition, an image generated by the clipping process is referred to as a clipped image.

Furthermore, the storage apparatus 104 stores history data including identification information on an image displayed in the frame (an image ID to be described later), frame information on the frame in which the image is arranged and displayed (a frame size and the like to be described later), and range information indicating a position of a part of the image displayed in the frame. Moreover, history data corresponds to each record of a clip information management table 700 to be described later. In addition, range information corresponds to a clip start position, a magnification ratio, and the like used in the clipping process to be described later.

Hereinafter, a display control process when arranging a first image in a first frame will be described.

When arranging the first image in the first frame, the control unit 101 acquires first history data including identification information on the first image and frame information on the first frame as corresponding history data from the storage unit and, based on range information in the corresponding history data, causes a part of the first image to be displayed in the first frame.

For example, when there is the same history data in the storage apparatus 104, the control unit 101 generates a clipped image with the same conditions as the history data. Accordingly, when there is the same history data, the creation of a clipped image can be omitted and efficiency can be improved.

If the first history data is not available when arranging the first image in the first frame, the control unit 101 acquires second history data including identification information on the first image and frame information on a frame with same vertical and horizontal sizes as the first frame as corresponding history data from the storage unit. Subsequently, based on range information in the corresponding history data, a part of the first image may be displayed in the first frame. Accordingly, when there is history data with the same frame size, work for displaying a part of the image can be omitted and efficiency can be improved.

If the first history data is not available when arranging the first image in the first frame, the control unit 101 acquires third history data including identification information on the first image and frame information on a frame with a same aspect ratio as the first frame as corresponding history data from the storage unit. Subsequently, based on range information in the corresponding history data, a part of the first image may be displayed in the first frame.

In addition, when displaying a part of the first image in the first frame based on range information in the third history data, the control unit 101 may magnify or demagnify the first image in accordance with vertical and horizontal sizes of the first frame. For example, the control unit 101 generates a clipped image by clipping a part of the first image in accordance with the vertical and horizontal sizes of the first frame and information in the “magnification ratio” item in the clip information management table 700 to be described later. Accordingly, when there is history data in which the aspect ratio of the frame is the same, a region of the image with a high likelihood of being specified by the user can be displayed in the frame and efficiency of work can be improved.

When there are a plurality of the third history data, the control unit 101 may acquire the third history data including frame information with a frame size which most closely resembles that of the first frame as the corresponding history data from the storage unit and use the range information in the corresponding history data.

In addition, history data may further include time/date information (an application timeddate to be described later) related to a performance of the clipping process. In this case, when there are a plurality of corresponding history data, the control unit 101 may use range information on the corresponding history data with the latest timdedate information. Accordingly, a clipped image with a higher likelihood of being created by the user can be generated.

If corresponding history data is not available when arranging the first image in the first frame, the control unit 101 may display, in the first frame, a region having been frequently displayed in the frame in the first image. Accordingly, a clipped image with a higher likelihood of being created by the user can be specified.

If corresponding history data is not available when displaying the first image in the first frame, the control unit 101 may display, in the first frame, a region having been frequently displayed in the frame in the first image. Accordingly, a range with a high likelihood of being required by the user can be displayed.

In addition, the control unit 101 may change a position in response to an instruction from the user and may cause a part of the first image which corresponds to the changed position to be displayed. In other words, the control unit 101 may change a range of the image to be displayed in accordance with an instruction by the user even after displaying a part of the image (a clipped image).

Moreover, the storage apparatus 104 stores application program software of a photo site according to the present embodiment (hereinafter, referred to as a “photo application”) as well as contents such as image files generated by imaging apparatuses.

However, the present embodiment is not limited thereto and operations may be performed in accordance with a keyboard operation or, when the display unit 111 is a touch panel having a touch sensor, operations may be performed in accordance with an output of the sensor.

Moreover, the information processing apparatus 100 may be realized with a single computer apparatus or realized by distributing the respective functions among a plurality of computer apparatuses as necessary. When the information processing apparatus 100 is constituted by a plurality of computer apparatuses, the computer apparatuses are connected by a communication line such as a local area network (LAN) so as to be capable of communicating with one another.

Processes by the Control Unit 101

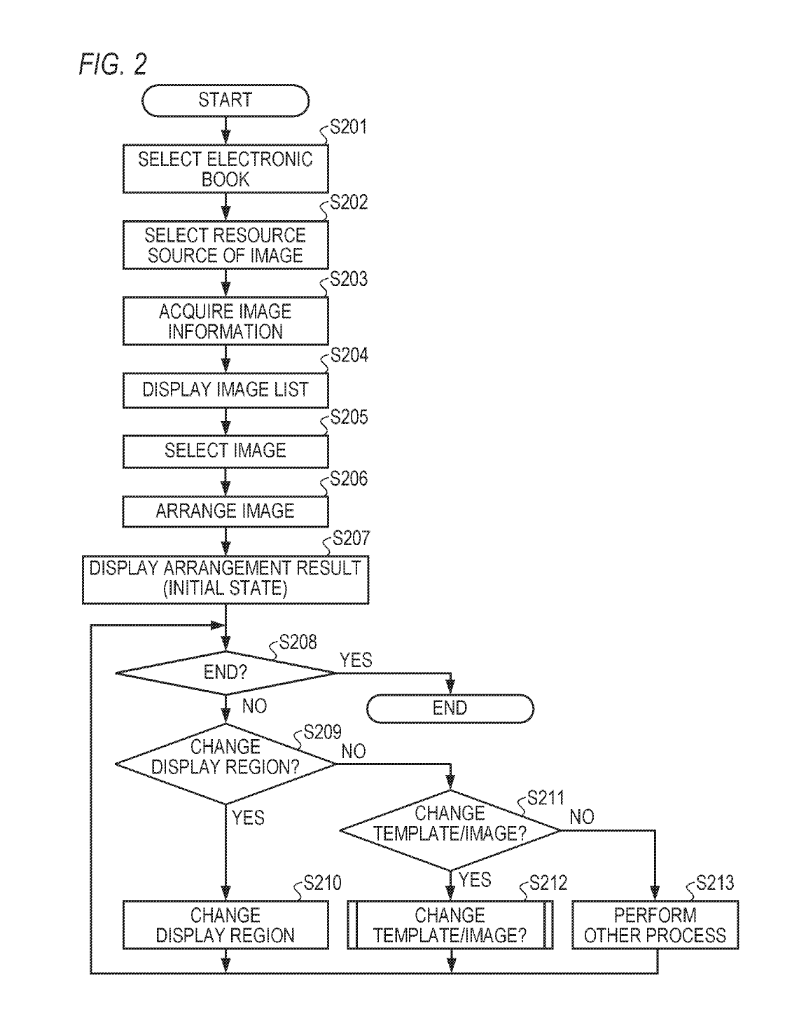

FIG. 2 is a flow chart showing an example of a process of creating an electronic book. The following process is realized as the control unit 101 of the information processing apparatus 100 reads an image layout application from the storage apparatus 104 and controls the respective modules described above in accordance with the image layout application. Moreover, the image layout application is a function of the photo application described earlier.

In step S201, the control unit 101 acquires an electronic book selected by the user. Specifically, the control unit 101 causes titles of electronic books currently being edited and those having already been edited to be displayed as a list on a screen, causes the user to select one of the titles, and acquires a book ID of the electronic book corresponding to the selected title from the storage apparatus 104. In this case, the book ID is a number for uniquely identifying an electronic book.

Using the book ID, the control unit 101 acquires the electronic book from the storage apparatus 104. In addition, when the user is to create a new electronic book, the control unit 101 generates a new electronic book and a new book ID corresponding to the new electronic book. Moreover, when having the user select an electronic book to be edited, the control unit 101 may display information such as titles and total number of pages of electronic books on the screen in addition to book IDs.

The following description of the flow chart shown in FIG. 2 concerns a case where a new electronic book is created.

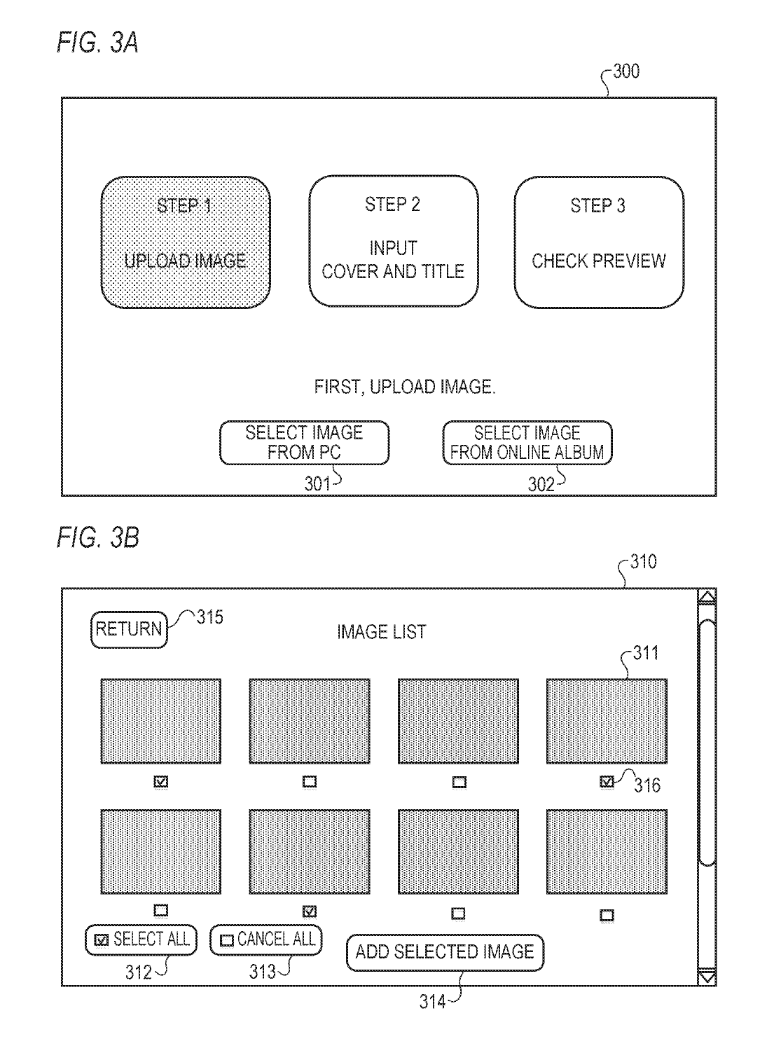

In step S202, the control unit 101 selects a resource source of an image to be laid out on a page of the electronic book. Specifically, the control unit 101 causes a resource source selection screen 300 shown in FIGS. 3A and 3B to be displayed and causes the user to select a resource source of an image.

FIGS. 3A and 3B are diagrams showing an example of a user interface for selecting image data. On the resource source selection screen 300 shown in FIG. 3A, a button 301 for selecting an image stored in the storage apparatus 104 of the information processing apparatus 100 as a resource source of an image is displayed. In addition, a button 302 for selecting an image stored in a storage apparatus which can be downloaded via the NET IF 109 of the information processing apparatus 100 is displayed. Furthermore, the control unit 101 detects that the user has pressed any of the button 301 and the button 302 and selects a resource source corresponding to the pressed button 301 or 302.

In step S203, the control unit 101 acquires image information from the resource source selected in step S202. For example, when the control unit 101 detects that the button 301 has been pressed by the user, the control unit 101 acquires a thumbnail image, a file name, and the like of an image stored in the storage apparatus 104. In addition, when the control unit 101 detects that the button 302 has been pressed by the user, the control unit 101 accesses via the NET I/F 109 a storage apparatus on the Internet or a LAN and acquires a thumbnail image, a file name, and the like of a stored image.

Moreover, in a case where an external storage apparatus is connected to the information processing apparatus 100, when the button 301 is pressed by the user, the control unit 101 may select the external storage apparatus (not shown) as the resource source.

In step S204, the control unit 101 generates display data of an image list screen 310 in accordance with the image information acquired in step S203 and causes the display unit 111 to display the image list screen 310. Thumbnail images 311 of image data stored in the selected resource source are displayed as a list on the image list screen 310 shown in FIG. 3B. The image list screen 310 shown in FIG. 3B also displays a “select all” button 312 for selecting all images, a “cancel all” button 313 for canceling the selection of all images, and an “add selected image” button 314 for ending a selection process of an image. In addition, the image list screen 310 shown in FIG. 3B displays a “return” button 315 for returning to the resource source selection screen 300 shown in FIG. 3A, and a check box 316 for selecting an image is displayed in a vicinity of each thumbnail image.

In step S205, the control unit 101 executes the selection process of an image by selecting an image with the check box 316 which has been checked by the user. Moreover, a user interface for selecting an image is not limited to that shown in FIG. 3B. For example, pressing the thumbnail image 311 may cause a frame to be displayed around the thumbnail image 311 to indicate a selected state of an image.

In step S206, once the selection process of the image ends, the control unit 101 generates display data in which each selected image is arranged on each page of the electronic book in an order of selection of the images.

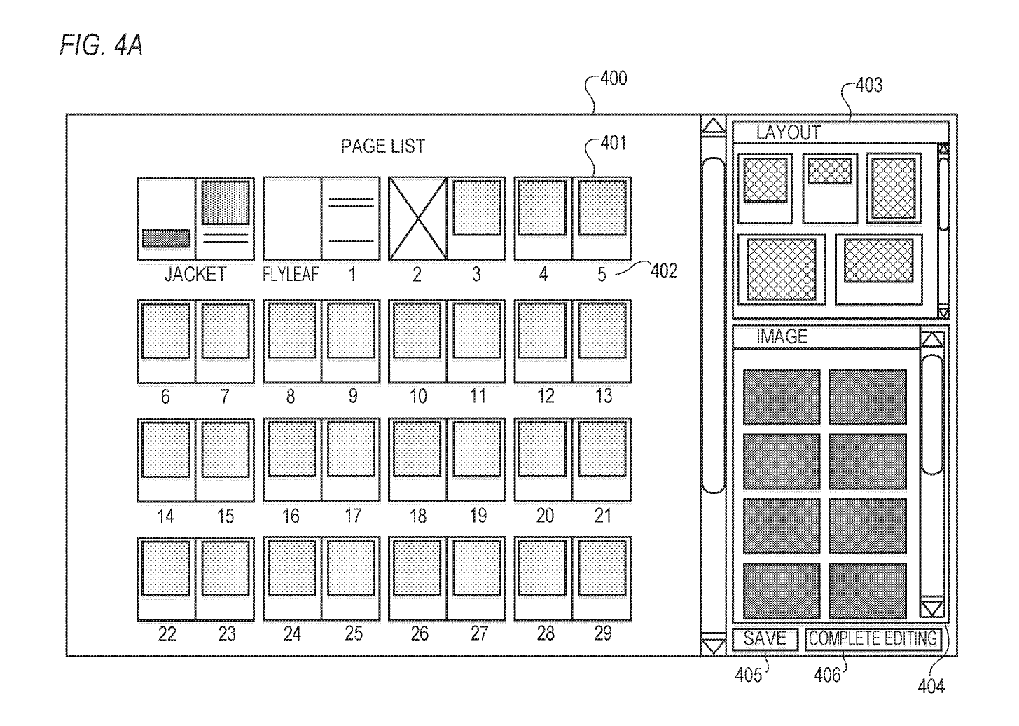

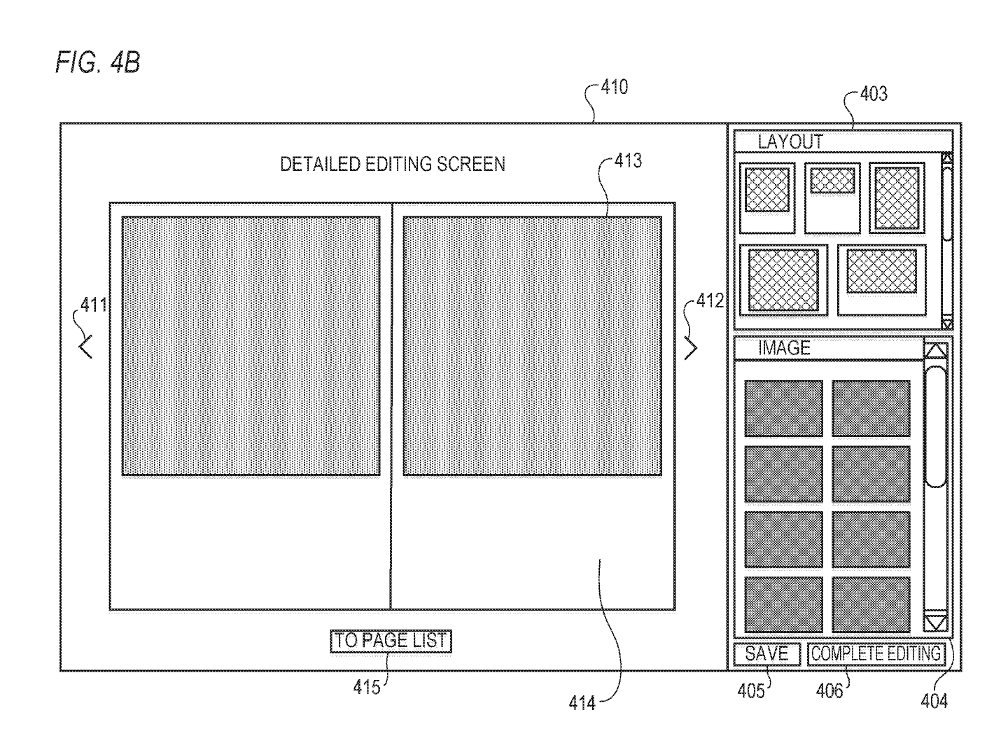

In step S207, based on the display data generated in step S206, the control unit 101 performs display control so as to cause the display unit 111 to display an editing screen 400 (FIG. 4A) showing an initial state of the electronic book.

FIGS. 4A and 4B are diagrams showing an example of a user interface for editing a page. The editing screen 400 displays respective pages 401 of the electronic book as a list of demagnified images. Each page 401 is displayed in a spread state and a page number 402 is added below each page. In addition, a selected image is displayed on each page 401.

When all of the pages 401 cannot be displayed within a region of the editing screen 400, the control unit 101 causes pages 401 from a first page to a midway page to be displayed in the editing screen 400 and causes subsequent pages 401 to be displayed in the editing screen 400 in accordance with a scrolling operation by the user.

In the example shown in FIG. 4A, as the initial state, a clipping process of an image is performed in accordance with a frame occupying upper ⅔ of each page and a clipped image created by the clipping process is arranged in the frame. Moreover, a configuration may be adopted in which initial states of a frame size and the like can be set by the user.

In addition, a layout region 403 and an image region 404 are arranged on a right side of the editing screen 400. Format images of templates used in pages are enumerated in the layout region 403. For example, in the example shown in FIG. 4A, the layout region 403 includes format images of a template for arranging an image in a frame occupying the upper ⅔ of a page, a template for arranging an image in a frame occupying an entire page, a template for arranging an image in a frame occupying two entire spread pages, and the like. The user can select a template to be applied to each page from the templates in the layout region 403.

Furthermore, a format image of a template shows a range and a position of a frame of an image in a page. For example, in the example shown in FIG. 4A, a portion of a frame occupying the upper ⅔ of a page is displayed filled by hatching in the format image corresponding to the template for arranging an image in a frame occupying the upper ⅔ of a page. Moreover, a process of changing a template will be described later.

In addition, the user can select an image to be arranged on each page from the images displayed as a list in the image region 404.

Moreover, while an example of left binding (a state where a right side of the book opens) is shown in the present embodiment in order to describe an application to a book-binding application which handles images and horizontally written comments regarding the images, the present embodiment is not limited to this example. For example, right binding may be adopted when handling vertically written comments, in which case left and right spread pages according to the present embodiment need only be reversed.

A save button 405 is a button for saving book data of the electronic book being edited. When the save button 405 is pressed, the control unit 101 saves the book data of the electronic book being edited of the user in the storage apparatus 104. When the book data of an electronic book is saved in this manner, the user can now select the electronic book in step S201.

The book data of the electronic book is updated every time the save button 405 is pressed, every time a clipped image is created as described later, and the like. Hereinafter, a data structure of the book data of an electronic book will be described.

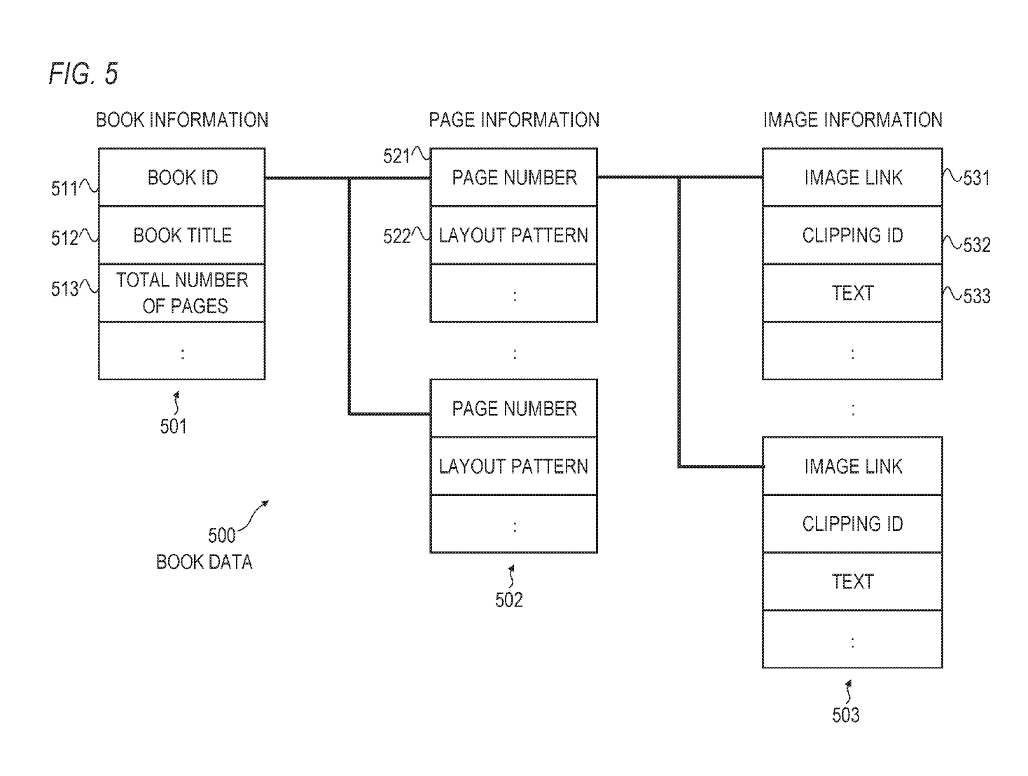

FIG. 5 is a diagram showing an example of a data structure of book data. Book data 500 has a hierarchical structure constituted by, in descending order from an upper layer, book information 501, page information 502, and image-related information 503, and each information has a link to a lower layer.

The book information 501 includes information related to the entire electronic book such as a book ID 511, a book title 512, and the total number of pages 513. The book ID 511 is information for uniquely identifying an electronic book. In addition, the book title 512 indicates a title of the electronic book and the total number of pages 513 indicates the total number of pages of the electronic book.

For example, in step S201, the control unit 101 refers to the book information 501 for each electronic book of which book data 500 is saved and causes the user interface to display the book ID 511, the book title 512, and the total number of pages 513 of each electronic book as a list. The user can refer to the book information 501 of each electronic book to select an electronic book to be edited. In addition, the control unit 101 may cause the user interface to display an image to be used as a cover of the electronic book. Once the electronic book being edited is selected, the control unit 101 respectively acquires the book information 501, the page information 502, and the image-related information 503 of the selected electronic book and causes the electronic book being edited to be displayed.

The page information 502 includes information related to each page such as a page number 521 which uniquely identifies a page in an electronic book and a layout pattern 522 of the page. The layout pattern is an identification number corresponding to a template applied to each page. When a template applied to a page is changed, the control unit 101 stores an identification number corresponding to the changed template in the layout pattern.

The image-related information 503 includes an image link 531 indicating a file path of an image to be laid out in each page and a clipping ID 532. The clipping ID 532 is an identification number uniquely assigned to each image subjected to a clipping process, and the image-related information 503 is associated with each record of the clip information management table 700 by the clipping ID 532. The clip information management table 700 is a table which manages information related to the clipping process of images. Moreover, a data structure of the clip information management table 700 will be described later.

In addition, the image-related information 503 includes a text 533 storing a comment related to an image.

When images are arranged in a spread layout, the image-related information 503 is associated with the page information 502 of one of the two pages constituting the spread page.

Let us now return to FIG. 4A. A complete editing button 406 is a button for completing the editing of an electronic book. When the complete editing button 406 is pressed, the control unit 101 saves the electronic book being edited of the user in the storage apparatus 104 and generates data for printing based on the saved electronic book.

Alternatively, the control unit 101 may cause a user interface for ordering printing to be displayed on the screen when the complete editing button 406 is pressed. The control unit 101 causes an input field for order information including the number of ordered copies, orderer information, shipping address information, and payment information to be displayed on the user interface. Once the order information is finalized, the control unit 101 transmits the order information to a terminal of a bookbinder. Moreover, details of the user interface for ordering printing will be omitted.

In a case where there is information having been updated by an operation performed by the user but is yet to be saved when the complete editing button 406 is pressed, the control unit 101 may display a pop-up to check with the user as to whether or not editing of the electronic book is to be completed.

FIG. 4B is a diagram showing an example of a detailed editing screen 410. When the user presses a thumbnail of a page 401 on the editing screen 400 of an electronic book, the detailed editing screen 410 of the pressed page 401 is displayed as shown in FIG. 4B. The detailed editing screen 410 includes a button 411 for making a transition to a leftward page (previous page), a button 412 for making a transition to a rightward page (next page), and an image thumbnail 413. Furthermore, the detailed editing screen 410 includes a region 414 for making a transition to a screen for text editing and a button 415 for returning to the editing screen 400 of the electronic book that is a transition source. In addition, the layout region 403, the image region 404, the save button 405, and the complete editing button 406 are displayed on the detailed editing screen 410 in a similar manner to the editing screen 400. Even on the detailed editing screen 410, the user can select a template to be applied to a page and select an image in a similar manner to the editing screen 400.

In addition, on the detailed editing screen 410, since an image is magnified over an entire display field of a thumbnail of the page 401 pressed on the editing screen 400, a state of each page upon completion of the electronic book can be more readily imagined.

Let us now return to FIG. 2. In steps S208 to S213, the control unit 101 performs an editing process of each page.

In step S208, when the complete editing button 406 is pressed by the user, the control unit 101 ends the process of the flow shown in FIG. 2 and continues the editing process of each page until the complete editing button 406 is pressed.

In step S209, when the image thumbnail 413 shown in FIG. 4B is pressed by the user, the control unit 101 causes a clipping process screen 600 for finalizing which portion of an image is to be subjected to a clipping process to be displayed in the image region of the template.

In step S210, the control unit 101 accepts creation of a clipped image on the clipping process screen 600.

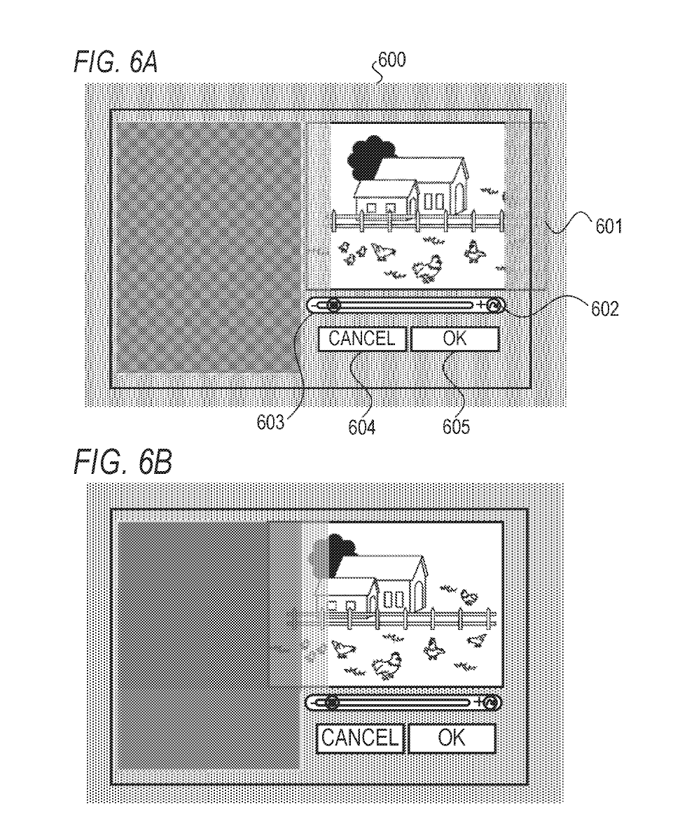

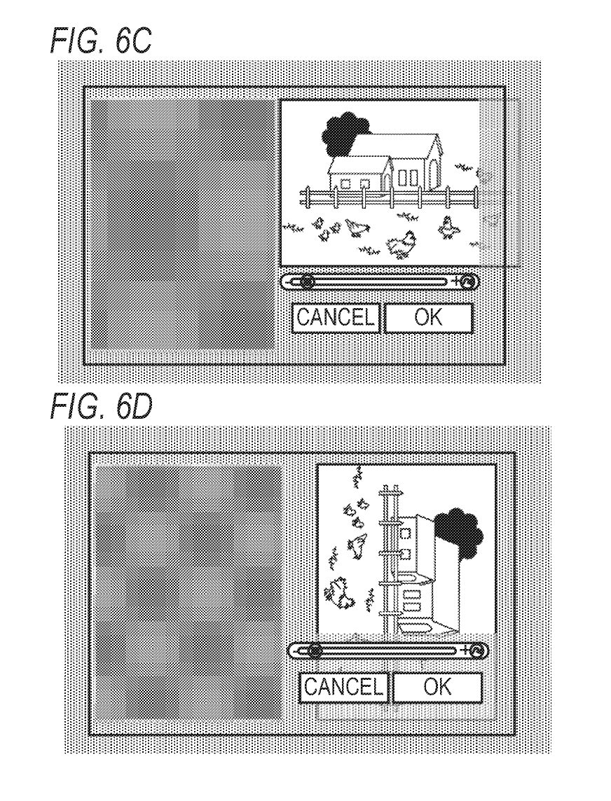

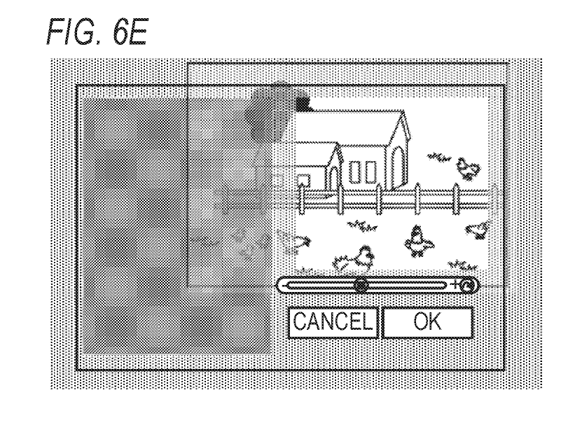

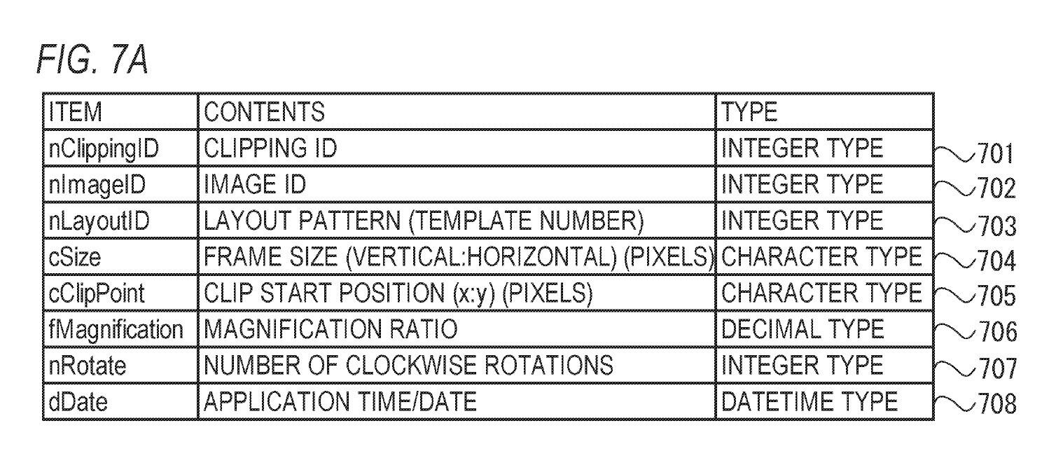

FIGS. 6A to 6E are diagrams showing an example of the clipping process screen 600. As shown in FIG. 6A, the clipping process screen 600 includes an image 601, a rotate button 602 for rotating the image, and a slider 603 for magnifying or demagnifying the image. In addition, the clipping process screen 600 includes a cancel button 604 for canceling the clipping process and an OK button 605 for finalizing the clipping process.

On the clipping process screen 600, a portion to be subjected to the clipping process in the image 601 is displayed brightly while other portions are displayed darkly. Accordingly, the user can confirm a portion to be included in a clipped image and a portion to be excluded from the clipped image of the image 601.

Moreover, the clipped image has a shape in accordance with the template selected in the layout region 403. In the example shown in FIG. 6A, a clipped image in a case where the template for arranging a region occupying the upper ⅔ of a page is selected.

By moving the image 601 using a mouse or the like, the user can change the portion of the image to be included in the clipped image. For example, when the user moves the image 601 to the left, a right end of the image 601 is included in the clipped image as shown in FIG. 6B, and when the user moves the image 601 to the right, a left end of the image 601 is included in the clipped image as shown in FIG. 6C. In addition, when the user presses the rotate button 602, a state where the image 601 is rotated clockwise by 90 degrees is created as shown in FIG. 6D. Alternatively, the control unit 101 may cause a pop-up for specifying a rotation angle of the image 601 to be displayed when the rotate button 602 is pressed and have the user specify the rotation angle in the pop-up.

Furthermore, when the user shifts the slider 603 rightward, the image 601 is magnified in proportion to an amount of the shift as shown in FIG. 6E. On the other hand, when the user shifts the slider 603 leftward, the image 601 is demagnified in proportion to an amount of the shift. Moreover, a user interface for magnifying the image 601 is not limited to the slider 603 and may be an input field or the like for inputting a magnification ratio of the image 601.

When the user desires to finalize a clipped image, the clipped image is finalized by pressing the OK button 605. On the other hand, when desiring to undo a clipped image, the original clipped image is restored by pressing the cancel button 604.

When the OK button 605 is pressed, the control unit 101 updates the clip information management table 700 stored in the storage apparatus 104. In the clip information management table 700, information such as the template applied to each page, a frame size, a position of an image, and a magnification ratio (a demagnification ratio) of the image is managed.

Next, a data structure of the clip information management table 700 will be described.

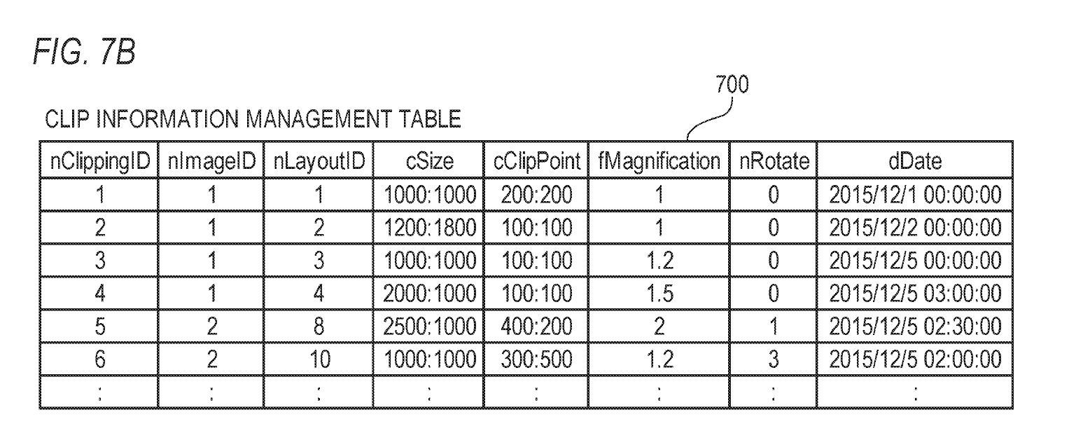

FIGS. 7A and 7B are diagrams showing an example of a data structure of the clip information management table 700. FIG. 7A shows contents and a data type of each item of the clip information management table 700, and FIG. 7B shows a data structure of the clip information management table 700. The clip information management table 700 includes a clipping ID (nClippingID), an image ID (nImageID), a layout pattern (nLayoutID), and a frame size (cSize). The clip information management table 700 further includes a clip start position (cClipPoint), a magnification ratio (fMagnification), the number of clockwise rotations (nRotate), and an application time/date (dDate).

The clipping ID is an identification number uniquely assigned to each clipped image and is generated every time a clipping process is performed. The image ID is an identification number assigned to each image used in an electronic book. The layout pattern is a number for identifying a template. The frame size respectively represents, in number of pixels, vertical and horizontal sizes of a frame in which an image is to be arranged.

The clip start position indicates a coordinate position (x, y) of a top left corner portion of a clipped image. Moreover, in the present embodiment, it is assumed that coordinates of a top left corner portion of an original image are (0, 0), a horizontal direction represents an X axis, and a vertical direction represents a Y axis.

The magnification ratio indicates a magnification ratio of an image subjected to the clipping process. The number of clockwise rotations indicates how many times an operation of rotating a graphic clockwise by 90 degrees has been performed. The application time/date indicates a time and date of execution of the clipping process.

The respective items described above are associated with each record of the clip information management table 700. Every time the OK button 605 shown in FIG. 6A is pressed, a record of the clip information management table 700 is added and information regarding a clipped image is recorded.

Let us now return to FIG. 2. When the user performs a process other than creating a clipped image and changing a template and an image in step S211, a transition is made to the process of step S213 and the control unit 101 performs the other process. For example, when the user edits a comment related to an image, the control unit 101 changes the text 533 of the image-related information 503 shown in FIG. 5.

On the other hand, when the user applies another template in the layout region 403 to a page or when the image in the page is changed to another image in the image region 404, the control unit 101 makes a transition to the process of step S212. Moreover, when an image in the image region 404 is arranged in a page on which an image has not been arranged, the control unit 101 similarly makes a transition to the process of step S212.

Moreover, an image in a page is changed by dragging a thumbnail of a desired image from inside the image region 404 and dropping the thumbnail on the page to be changed. When changing a template, a template applied to a page is similarly changed by dragging a format image of a desired template from inside the layout region 403 and dropping the format image on the page to be changed.

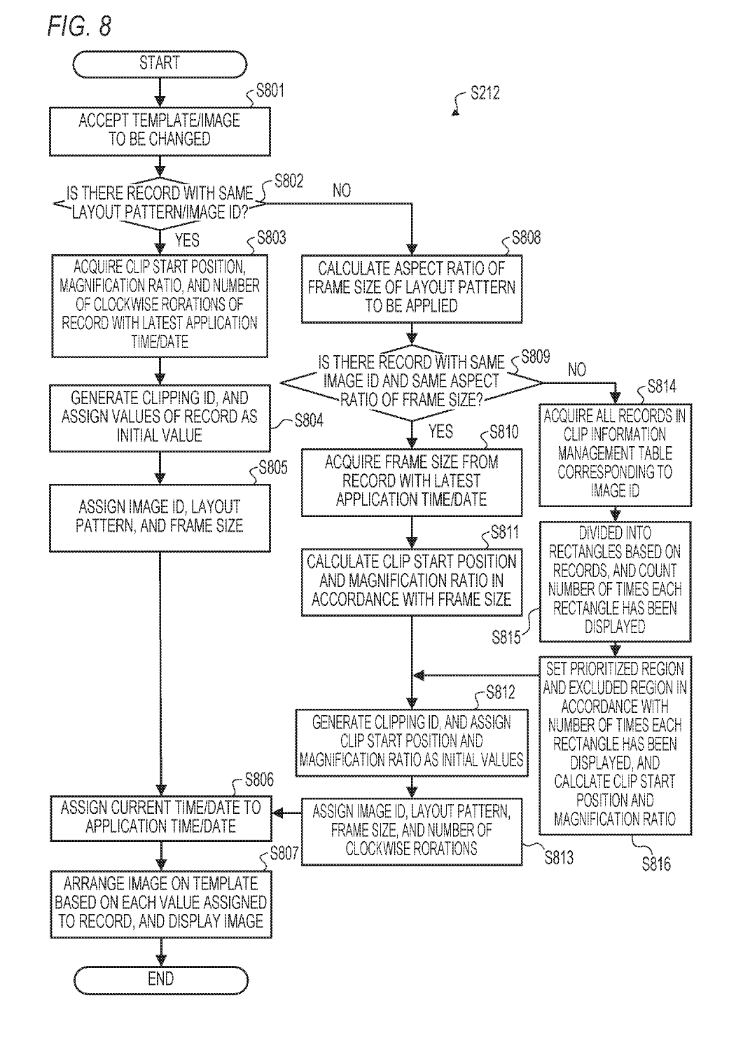

FIG. 8 is a flow chart of a process for changing a template or an image in response to an instruction by the user. The flow chart shown in FIG. 8 corresponds to step S212 in FIG. 2 and represents a process of setting an initial value of a clipped image when changing a template and an image.

In step S801, the control unit 101 accepts a template or an image to be changed as specified by the user.

In step S802, the control unit 101 refers to the clip information management table 700 and determines whether or not there exists a record with same contents as a combination of a layout pattern and an image ID to be changed. For example, when applying an image with an image ID of “1” to a template with a layout pattern of “3”, the control unit 101 refers to the clip information management table 700 shown in FIG. 7B and determines that a clipping ID of “3” represents the same contents.

When the control unit 101 determines that there exists a record with the same layout pattern and image ID in the clip information management table 700, the control unit 101 makes a transition to the process of step S803. In step S803, the control unit 101 acquires a clip start position 705, a magnification ratio 706, and the number of clockwise rotations 707 of a record with a latest application time/date 708 among corresponding records of the clip information management table 700.

In step S804, the control unit 101 generates and inputs a new clipping ID 701 into a new record of the clip information management table 700. In addition, the control unit 101 inputs the clip start position 705, the magnification ratio 706, and the number of clockwise rotations 707 acquired in step S803 as initial values to the new record.

In step S805, the control unit 101 further inputs an image ID 702, a layout pattern 703, and a frame size 704 to the new record. In step S806, the control unit 101 further inputs the current time and date to the application time/date 708 of the new record.

In step S807, the control unit 101 arranges an image in a template based on values of the new record and causes the image to be displayed on the editing screen 400 (or the detailed editing screen 410).

A path via steps S803 to $805 described above is a path taken in a case where a record with a combination of the same layout pattern and image ID is found in the clip information management table 700. On this path, a latest record among corresponding records is to be reflected as an initial value of the clipping process.

When the control unit 101 determines in S802 that a record with the same layout pattern and image ID does not exist in the clip information management table 700, the control unit 101 makes a transition to the process of step S808. In step S808, the control unit 101 calculates an aspect ratio of the frame size of the applied template.

In step S809, the control unit 101 determines whether or not there exists a record with the same image ID and the same aspect ratio of a frame size in the clip information management table 700. For example, when applying an image with an image ID of “1” to a template of which vertical and horizontal frame sizes are (600, 900) (pixels), the control unit 101 determines that the aspect ratio of the frame size of the clipping ID of “2” in the clip information management table 700 represents the same contents.

When the control unit 101 determines that there exists a record with the same image ID and the same aspect ratio of the frame size, the control unit 101 makes a transition to the process of step S810. In step S810, when there are a plurality of corresponding records, the control unit 101 acquires a frame size from a record with the latest application time/date among the corresponding records. Next, in step S811, the control unit 101 calculates a clip start position and a magnification ratio of a clipped image in accordance with the acquired frame size.

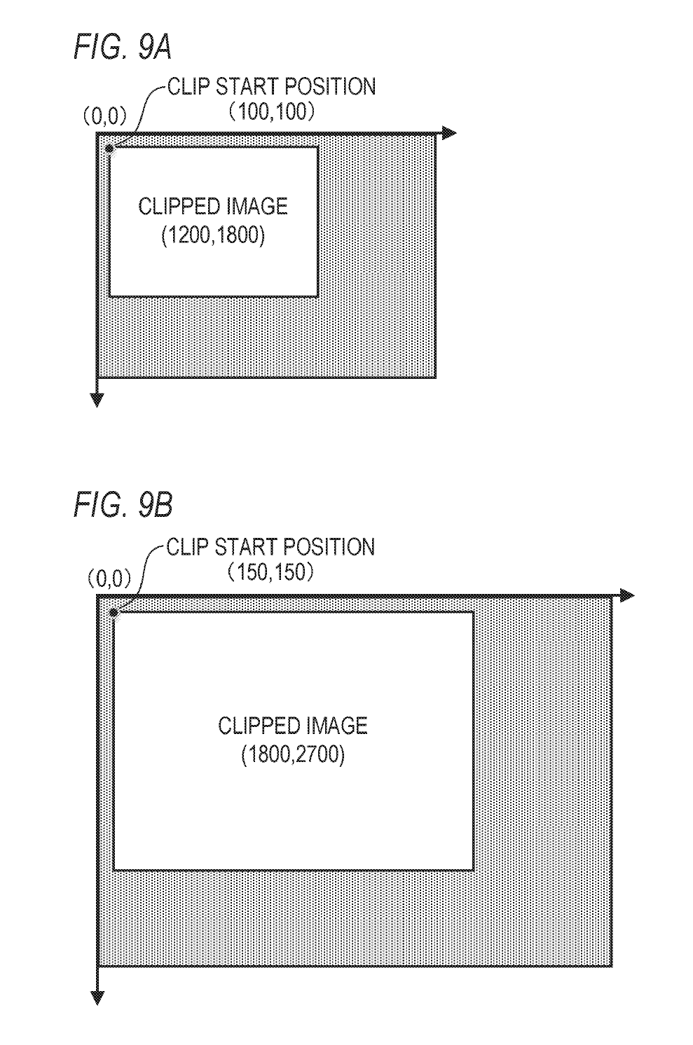

The acquisition of a clip start position and a magnification ratio of a clipped image when there is a record with a same aspect ratio of the frame size will be described with reference to FIGS. 9A and 9B.

FIGS. 9A and 9B are diagrams showing an example of a process of acquiring a clip start position and a magnification ratio. In FIGS. 9A and 9B, a hatched region indicates an entire image and a region of a clipped image is shown in the hatched region. FIG. 9A is a diagram showing a clipped image of a record with the clipping ID of “2” in the clip information management table 700. FIG. 9B is a diagram showing a clipped image in a case where a clipping process is performed in accordance with the frame size using the record with the clipping ID of “2”.

Hereinafter, a case of generating a clipped image shown in FIG. 9B from an original image based on a record with the clipping ID of “2” in the clip information management table 700 which corresponds to the clipped image shown in FIG. 9A will be described.

With respect to the clipped image represented by the record with the clipping ID of “2”, when the top left of the image is assumed to be an origin (0, 0) as shown in FIG. 9A, the clip start position is (100, 100) and the numbers of vertical and horizontal pixels of the clipped image are (1200, 1800). On the other hand, as shown in FIG. 9B, the numbers of vertical and horizontal pixels of the frame of the template to be applied are (1800, 2700), which indicates that the frame size has increased by a factor of 1.5 in both vertical and horizontal directions as compared to FIG. 9A.

In this case, the control unit 101 magnifies the original image by a factor of 1.5, changes the clip start position to (150, 150) in accordance with the magnification by a factor of 1.5, and generates the clipped image shown in FIG. 9B. In this manner, the control unit 101 generates a clipped image based on a record in the clip information management table 700 and performs a process of magnifying (demagnifying) the clipped image and subsequently shifting the start position.

Let us now return to FIG. 8. In step S812, the control unit 101 newly generates a clipping ID 701 and inputs the clipping ID 701 into a new record of the clip information management table 700. In addition, the control unit 101 inputs the clip start position and the magnification ratio of the image calculated in step S811 to the new record.

In step S813, the control unit 101 further inputs the image ID 702 of the image subjected to a clipping process, the layout pattern 703 of the template, the frame size, and the number of clockwise rotations 707 during the clipping process to the new record.

In step S806, the control unit 101 inputs the current time and date to the application time/date 708 of the new record.

In step S807, the control unit 101 arranges an image in a template based on values of the new record and causes the image to be displayed on the editing screen 400 (or the detailed editing screen 410).

In a path via the steps S810 and S811 described above, when a record with the same aspect ratio of the frame size is found in the clip information management table 700, a magnification ratio and a clip start position in accordance with the aspect ratio are to be set to the initial values of the clipping process.

When the control unit 101 determines in step S809 that a record with the same image ID and the same aspect ratio of the frame size does not exist, the control unit 101 makes a transition to the process of step S814.

In step S814, the control unit 101 acquires all records in the clip information management table 700 corresponding to the image ID of the clipped image.

In step S815, the control unit 101 divides an image into rectangles based on values of each record and counts, for each rectangle, the number of times the rectangle has been displayed.

In step S816, the control unit 101 sets a prioritized region and an excluded region in accordance with the number of times each rectangle has been displayed and sets a magnification ratio (a demagnification ratio) and a clip start position of a clipped image in a range which includes the prioritized region but, at the same time, excludes the excluded region. In this case, a prioritized region refers to a region to be preferentially adopted as a clipped image in the clipping process. For example, the control unit 101 sets a rectangular region with the largest number of times displayed as a prioritized region. In addition, an excluded region refers to a region to be excluded from a clipped image. For example, the control unit 101 sets a region which has never been displayed or a region displayed the smallest number of times as an excluded region.

For example, the control unit 101 sets the magnification ratio of the clipped image to a lowest magnification ratio which enables the clipped image to include the prioritized region. Furthermore, the control unit 101 sets the clip start position to a position which enables the clipped image to include the entire prioritized region and, at the same time, prevents the clipped image from being included in the excluded region.

On the other hand, there are cases where, even when the magnification ratio of the clipped image is set to a lowest magnification ratio which enables the clipped image to include the prioritized region and the clipped image is arranged so that the entire prioritized region is included in the clipped image, the clipped image inevitably includes the excluded region no matter how the clipped image is arranged.

In this case, the control unit 101 may set the magnification ratio of the clipped image to a lowest magnification ratio which enables the clipped image to include the prioritized region and set the clip start position to a position which enables the clipped image to include the entire prioritized region but, at the same time, minimizes an area of the clipped image included in the excluded region.

Specifically, the control unit 101 compares a ratio of a length of a vertical side of the clipped image to a length of a vertical side of the prioritized region (vertical side of prioritized region/vertical side of clipped image) with a ratio of a length of a horizontal side of the clipped image to a length of a horizontal side of the prioritized region (horizontal side of prioritized region/horizontal side of clipped image). Next, the control unit 101 sets the magnification ratio of the clipped image so that a length of the side of whichever has the larger ratio becomes equal to a length of the side of the prioritized region. Subsequently, the control unit 101 sets the clip start position of the clipped image to a position which enables the clipped image to include the entire prioritized region and, at the same time, minimizes an area of the clipped image included in the excluded region.

Alternatively, the control unit 101 may set the magnification ratio and the clip start position within a range which prevents the clipped image from being included in the excluded region and which maximizes an area of the clipped image included in the prioritized region.

Specifically, the control unit 101 compares a ratio of a length of a vertical side of the clipped image to a length of a vertical side of the prioritized region (vertical side of prioritized region/vertical side of clipped image) with a ratio of a length of a horizontal side of the clipped image to a length of a horizontal side of the prioritized region (horizontal side of prioritized region/horizontal side of clipped image). Next, the control unit 101 sets the magnification ratio of the clipped image so that a length of the side of whichever has the smaller ratio becomes equal to a length of the side of the prioritized region. Subsequently, the control unit 101 sets the clip start position within a range which prevents the clipped image from being included in the excluded region and which maximizes an area of the clipped image included in the prioritized region.

Moreover, conditions of the prioritized region and the excluded region may be changed as appropriate.

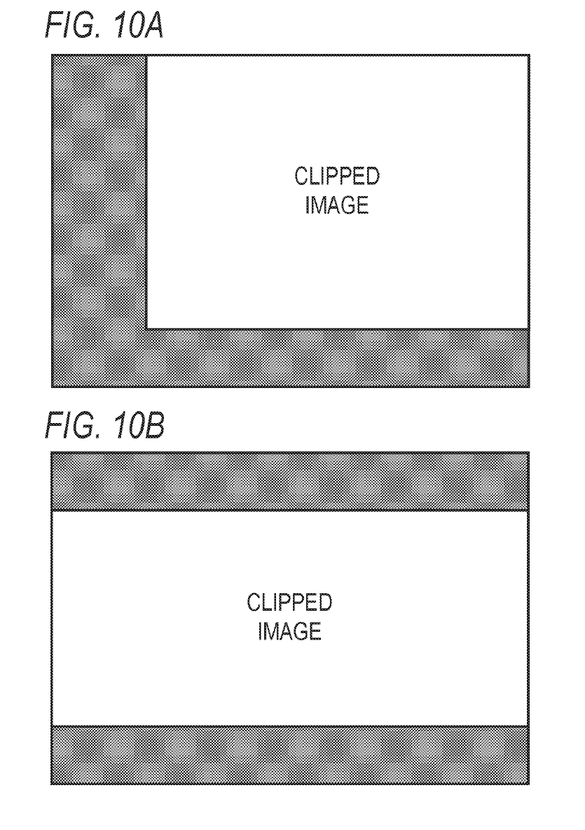

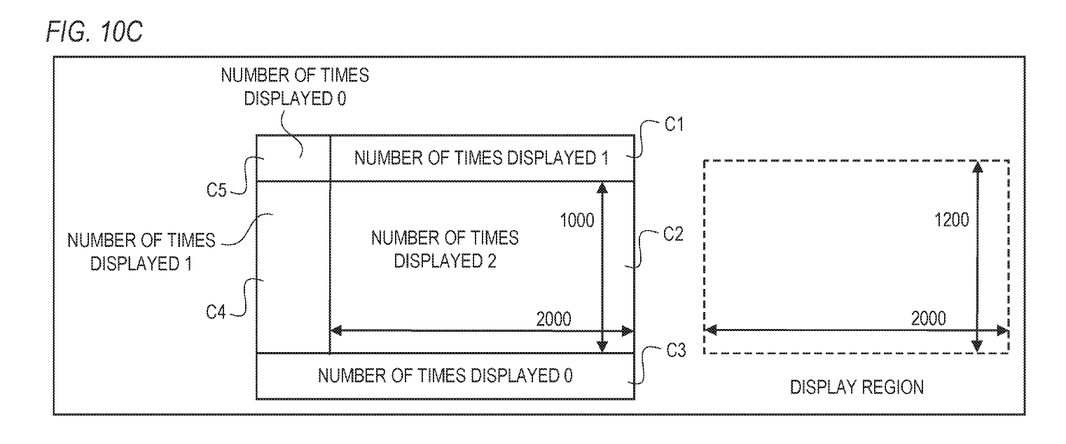

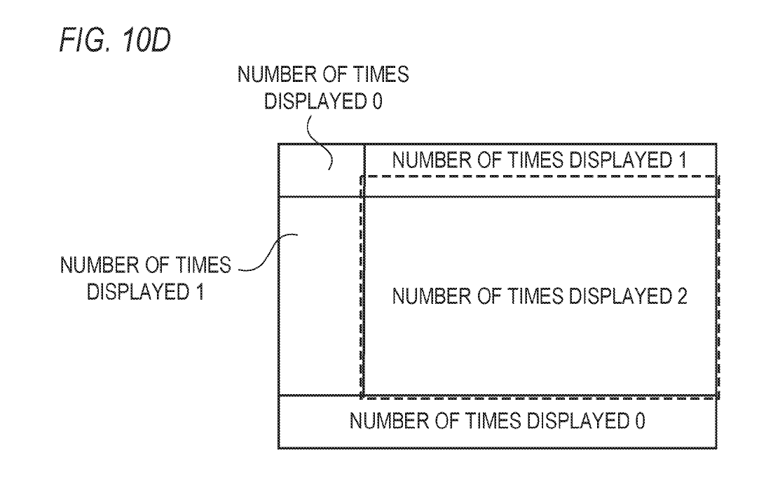

FIGS. 10A to 10D are diagrams showing an example of settings of a prioritized region and an excluded region. FIGS. 10A and 10B are diagrams exemplifying clipped regions of an image. The portions not hatched in FIGS. 10A and 10B represent clipped images. Let us assume that records corresponding to FIGS. 10A and 10B exist in the clip information management table 700.

FIG. 10C shows a division into rectangles in accordance with the two clipping processes represented by FIGS. 10A and 10B and shows, for each rectangle, the number of times the rectangle has been displayed, in which the number of times rectangles c1 and c4 are displayed is 1, the number of times a rectangle c2 is displayed is 2, and the number of times rectangles c3 and c5 are displayed is 0.

In this case, the control unit 101 sets the rectangle c2 displayed twice which represents the largest number of times a rectangle has been displayed as the prioritized region and sets the rectangles c3 and c5 of which the number of times the rectangles have been displayed is 0, meaning that the rectangles c3 and c5 have never been displayed, as the excluded region.

When the vertical and horizontal sizes of the rectangle c2 which is the prioritized region are (1000, 2000) (pixels) and the vertical and horizontal sizes of the frame are (1200, 2000), the control unit 101 specifies a range depicted by a dotted line in FIG. 10D which includes the rectangle c2 but does not include the rectangles c3 and c5. Next, the control unit 101 sets the magnification ratio and the clip start position of an image based on the range depicted by the dotted line in FIG. 10D.

Let us now return to FIG. 8. Processes of steps S812, S813, S806, and S807 subsequent to step S816 are similar to the processes in the path via the steps S810 and S811.

With a path via the steps S814 to S816 described above, when a record with the same aspect ratio of the frame size is not found in the clip information management table 700, the number of times each rectangle has been displayed is counted and initial values of the clipping process are to be set in accordance with the number of times each rectangle has been displayed.

Moreover, while a description has been given of the control unit 101 acquiring, when there are a plurality of records with the same image ID and the same aspect ratio of a frame size, a frame size from a record with the latest application time/date among the corresponding records in step S810, the control unit 101 is not limited to this process. The control unit 101 may acquire a frame size from a record with the closest frame size among the corresponding records. For example, when there is a record with the same frame size among the corresponding records, the control unit 101 may acquire the frame size from the record.

Moreover, while processes in a case where a new electronic book is created have been described above, when an electronic book being edited is selected in step S201, the flow charts shown in FIGS. 2 and 8 can be applied to pages of which editing has not been completed.

By performing a clipping process as described above, specification of a range of an image to be subjected to the clipping process can be omitted when changing an image to be arranged on a page or changing a template to be applied to a page, and occurrences of rework can be suppressed. In addition, even with respect to pages yet to be edited, a clipped image can be similarly generated based on a history of clipping processes of pages already edited and previous work can be effectively utilized. Accordingly, efficiency of work for creating an electronic book can be improved.

### Other Embodiments

While a clipping process of an image is performed based on the clip information management table 700 which is generated for each electronic book in the embodiment described above, this configuration is not restrictive. The clipping process of an image may be performed based on the clip information management table 700 of another electronic book.

While the control unit 101 generates a clipped image based on a frame size, a clip start position, a magnification ratio, and the like in the clip information management table 700 in the embodiment described above, a method of generating a clipped image is not limited thereto. For example, the clip information management table 700 may further store a clip tail-end position indicating a coordinate position (x, y) of a diagonally lower right corner of a clipped image as an item, and the control unit 101 may generate a clipped image using the clip tail-end position. Moreover, in this case, the clip information management table 700 need not store the magnification ratio item and may calculate a magnification ratio based on the clip start position, the clip tail-end position, and the frame size.

Alternatively, the control unit 101 may generate a clipped image based on the clip start position, the magnification ratio, the clip tail-end position described above, and the like.

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like. Furthermore, the present invention can also be realized by executing the processes described below. Specifically, the present invention can also be realized by supplying software (a program) that realizes functions of the embodiments described above to a system or an apparatus via a network or various storage media and having a computer (or a CPU, an MPU, or the like) in the system or the apparatus read and execute the program.

Furthermore, means of realizing the functions of the embodiments described above are not limited to the execution of a read program by a computer. For example, it is needless to say that cases where, based on instructions of the program, an operating system (OS) or the like running on the computer performs a part of or all of the actual processes and the functions of the embodiments described earlier are realized by the processes are also included in the present invention.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2017-104300, filed on May 26, 2017, which is hereby incorporated by reference herein in its entirety.

What is claimed is:

1. An information processing apparatus, comprising:
a display controlling unit configured to control display so that a part of an image is displayed in a frame; and
a storage unit configured to store history data including identification information for uniquely identifying the image, frame information for uniquely identifying the frame in which the image is displayed, and range information indicating a position of the part of the image displayed in the frame, wherein
in a case of displaying a first image in a first frame, the display controlling unit acquires first history data including identification information on the first image and frame information on the first frame from the storage unit as corresponding history data, and controls display so that a part of the first image, which corresponds to a position indicated by range information in the corresponding history data, is displayed in the first frame.

2. The information processing apparatus according to claim 1, wherein
in a case of displaying the first image in the first frame, if there is no the first history data, the display controlling unit acquires second history data including identification information on the first image and frame information on a frame having same vertical and horizontal sizes as the first frame as corresponding history data from the storage unit, and controls display so that the part of the first image, which corresponds to a position indicated by range information in the corresponding history data, is displayed in the first frame.

3. The information processing apparatus according to claim 1, wherein
in a case of displaying the first image in the first frame, if there is no the first history data, the display controlling unit acquires third history data including identification information on the first image and frame information on a frame having the same aspect ratio as the first frame as corresponding history data from the storage unit, and controls display so that the part of the first image, which corresponds to a position indicated by range information in the corresponding history data, is magnified or demagnified and then displayed in the first frame.

4. The information processing apparatus according to claim 3, wherein
in a case where there are a plurality of third history data, the display controlling unit uses range information on third history data including frame information on a frame of which the vertical and horizontal lengths of which most closely resemble those of the first frame.

5. The information processing apparatus according to claim 1, wherein
the history data further includes time/date information which indicates a time and date at which an image represented by the identification information included in the history data has been displayed in a frame represented by the frame information included in the history data, and
in a case where there are a plurality of corresponding history data, the display controlling unit uses range information on corresponding history data with the latest time/date information.

6. The information processing apparatus according to claim 1, wherein
in a case of displaying the first image in the first frame, there is no corresponding history data, the display controlling unit controls display so that a region, having been frequently displayed in the frame in the first image, is displayed in the first frame.

7. The information processing apparatus according to claim 1, wherein
the display controlling unit changes the position in response to an instruction from a user and controls display so that the part of the first image, which corresponds to the changed position, is displayed.

8. An information processing method, comprising:
controlling display so that a part of an image is displayed in a frame; and
recording, in a storage unit, history data including identification information for uniquely identifying the image, frame information for uniquely identifying the frame in which the image is displayed, and range information indicating a position of the part of the image displayed in the frame, wherein
in a case of displaying a first image in a first frame, in the controlling,
first history data including identification information on the first image and frame information on the first frame is acquired from the storage unit as corresponding history data, and
display is controlled so that a part of the first image, which corresponds to a position indicated by range information in the corresponding history data, is displayed in the first frame.

9. A non-transitory computer readable medium that stores a program, wherein the program causes a computer to execute:
controlling display so that a part of an image is displayed in a frame; and
recording, in a storage unit, history data including identification information for uniquely identifying the image, frame information for uniquely identifying the frame in which the image is displayed, and range information indicating a position of the part of the image displayed in the frame, and
in a case of displaying a first image in a first frame, in the controlling,
first history data including identification information on the first image and frame information on the first frame is acquired from the storage unit as corresponding history data, and
display is controlled so that a part of the first image, which corresponds to a position indicated by range information in the corresponding history data, is displayed in the first frame.
